(19) United States
(12) Patent Application Publication
(10) Pub. No.: US 2003/0177042 A1
(43) Pub. Date: Sep. 18, 2003

(54) Computerized clinical messaging system

(76) Inventor: Richard Leon, Weston, FL (US)

Correspondence Address: Oltman, Flynn & Kubler, 415 Galleria Professional Building, 915 Middle River Drive, Ft. Lauderdale, FL, 33304, US

(21) Appl. No.: 10/314,977

(22) Filed: Dec. 10, 2002

Related U.S. Application Data
(63) Continuation-in-part of application No. 10/097,512, filed on Mar. 15, 2002.

(51) Int. Cl. G06F 17/60; H04N 1/00; G06F 7/00; G06F 17/00

(52) U.S. Cl. 705/3; 358/400; 707/104.1

(57) ABSTRACT

A computer operated clinical messaging system for receiving, categorizing, storing and selectively retrieving clinical messages through the World Wide Web includes at least one originating source at which a user inputs and retrieves data; a clinical messaging report processing program including a number of report templates for matching corresponding report categories and accessing mechanisms for a receiving, categorizing, storing and selectively retrieving client reports by report category; a web browser, where the clinical messaging client application program resides and executes in the web browser; a centralized data repository functioning as a user interface and connected to the at least one originating system via the World Wide Web; and a clinical messaging report interface for importing and extracting data from reports received from the at least one originating source from the at least one originating source. The clinical messaging report processing program preferably includes a mechanism for a receiving, categorizing, storing and selectively retrieving client reports by overlapping a number of report categories.

### FILING HISTORY

This application is a continuation-in-part of application Ser. No. 10/097,512 filed on Mar. 15, 2002.

### BACKGROUND OF THE INVENTION

1. Field of the Invention

The present invention relates generally to computerized information distribution systems. More specifically the present invention relates to a computer-operated clinical messaging system for receiving, categorizing, storing and selectively retrieving through the World Wide Web clinical messages, these messages typically taking the form of clinical reports of doctors about patients.

The system includes at least one originating source such as the computer system of a hospital or of a doctor office at which a user such as a doctor or medical staff member inputs and retrieves data; a web server for sending data to the client program; a centralized data repository located in a main data center running a report processing program and connectable to the originating source via the World Wide Web. The clinical messaging client application program includes means for accessing client reports by type or category, such as radiology, lab, or transcription, generated over a given selected date range and such as by patient name, medical record number, test name or date. The web server preferably encrypts the data so that all data passed to the clinical messaging client application program is sent via an encrypted SSL connection to the browser where the program resides. The system includes a clinical messaging report processing program for reading reports received from the clinical messaging report interfaces and for loading the reports into the clinical messaging data repository. The clinical messaging report processing program pulls data off the reports and uses this data to populate the database as well as the report itself. The clinical messaging report processing program has built-in profiles for each report type it processes. The system includes a clinical messaging faxing system. The clinical messaging data repository preferably contains a user database which stores user profiles and preferences and user authentication credentials.

A method of operating the system is provided including the following steps: A user transmits data constituting a clinical report(s); the main data center receives the report and compares the report with templates stored in the logic of the clinical messaging report processing program until a matching template is found; the clinical messaging report processing program processes the report according to the rules of the matching template; the data reporting storing the processed report in the clinical messaging data repository in such a manner as to be accessible for viewing; a user operates a computer station at an originating source to select one or more of these reports by patient name or by data category and accesses the report(s) and views, prints and/or telefaxes the report(s).

2. Description of the Prior Art

There have in recent years been information distribution systems for providing access to and distribution of medical files and records. One such prior system is disclosed in Bessette, U.S. Pat. No. 6,263,330 B1, issued on Jul. 17, 2001, disclosing a method and apparatus for the management of data files. Bessette stores records in a database on a server, permitting a client work-station to download a record along with a set of pointers which link the record to remotely stored files, each pointer permitting a physician to select points of interest to avoid downloading large amounts of data not needed at the moment. Bessette also permits the physician to make statistical queries.

Wong, et al., U.S. Pat. No. 6,260,021 B1, issued on Jul. 10, 2001 teaches a computer-based medical image distribution system and method. Wong, et al. has a three-tiered information system architecture, and includes at least one interface engine for providing image objects with uniform structure, and has image server middleware for managing the distribution of image objects. Wong, et al. further includes a security object server for authorizing user access to the image distribution system and to particular objects, a personalization object server for providing user interface preferences and client workstation capabilities and a web server for downloading initial access pages and user interface components. Wong, et al. also provides a method for medical image distribution.

Whalen, et al., U.S. Pat. No. 5,327,341, issued on Jul. 5, 1994, reveals a computerized file maintenance system for managing medical records including narrative reports. Whalen, et al. is a program which utilizes data files but permits the reading of a particular record or combination of records in a file and permits the reader to make changes and corrections in an existing record. These records have report fields that are large enough to make it impractical to retype the entire record as in a standard field defined record. The files have record sets in an organizational structure combining a number of records with identical text fields of fixed character length with a number of hybrid categorical, extended-field records of virtually unlimited character length.

Coli, et al., U.S. Pat. No. 6,018,713, issued on Jan. 25, 2000, discloses an integrated system and method for ordering and cumulative results for reporting of medical tests. For one embodiment, the Coli, et al. network includes a number of personal computers each of which is logically connected to an intermediate computer which may be connected to a database computer. File and resource serving functions collect requests from all computers associated with the network scheduler and satisfies them either by immediately processing the request internally or by routing the request to the patient database computer. This embodiment is stated to enhance communication among differing segments of the health care profession by providing a system and method for ordering and cumulative results reporting of medical tests through a remote terminal interacting over a telephone line with a host computer.

Seto, et al., U.S. Pat. No. 6,157,914, issued on Dec. 5, 2000, teaches a medical support system for centrally managing medical information generated by more than one hospital and for facilitating medical information interchange among hospitals. Seto, et al., includes a number of storage means storing information about patients, entry means for entering identification information to identify a specific patient, identifying means responsive to the identification information for identifying a number of storage means that store medical information about the specific patient; and access means for accessing the storage means identified by the identifying means by the identification information to read out medical information about the specific patient.

It is thus an object of the present invention to provide a computerized clinical messaging system which permits physicians to gain rapid access to clinical reports from their homes and offices, from hospitals and while on the road using graphical interface which initiates several activities with the push of one web site button to produce a result desired by a typical physician.

It is yet another object of the present invention to provide such a system which receives existing reports and pulls data off the reports to populate a central data repository and the reports themselves and which converts these reports into clinical reports viewable on the World Wide Web and which categorizes by matching the reports with templates and image maps so that the reports are selectively accessible from an Internet PC by type, such as radiology, lab, or transcription reports, by date such as by reports generated over a given selected date range and by content, such as by patient name, medical record number, test name or date and by groups defined by overlaps of several of these categories stacked one on top of the other.

It is another object of the present invention to provide such a system which optionally includes an auto pilot which periodically searches and telefaxes or prints reports falling into a certain selected category or overlapping categories, and which is operated simply.

It is yet another object of the present invention to provide such a system which is easy for a typical physician to enter and operate using clinician terminology and which is clinical focused.

It is still another object of the present invention to provide such a system which provides physicians and their offices with an application which is flexible, which gives them the ability to manage their reports, and which maintains a high level of security to protect patient privacy through encryption.

It is finally an object of the present invention to provide such a system which provides a high level of customer services to the physician and his or her office staff to support clinical messaging, which is capable of replacing existing systems and which can reuse funding to develop and maintain in-house developed applications.

### SUMMARY OF THE INVENTION

The present invention accomplishes the above-stated objectives, as well as others, as may be determined by a fair reading and interpretation of the entire specification.

A computer operated clinical messaging system is provided for receiving, categorizing, storing and selectively retrieving clinical messages through the World Wide Web, the system including at least one originating source at which a user inputs and retrieves data; a clinical messaging report processing program including a number of report templates for matching corresponding report categories and accessing mechanisms for a receiving, categorizing, storing and selectively retrieving client reports by report category; a web browser, where the clinical messaging client application program resides and executes in the web browser; a centralized data repository running the clinical messaging report processing program and connected to the at least one originating system via the World Wide Web; and a clinical messaging report interface for importing and extracting data from reports received from the at least one originating source from the at least one originating source.

The clinical messaging report processing program preferably includes a mechanism for a receiving, categorizing, storing and selectively retrieving client reports by overlapping a number of report categories. The application program preferably is an ActiveX Document which is accessed via Internet Explorer. The report categories preferably include at least one of: radiology reports, lab reports, transcription reports, reports generated over a selected date range, reports for a patient having a certain patient name. The originating source may be a computer system in a hospital. The originating source may be a computer system in a doctor office. The clinical messaging client application program preferably includes an automated printing subroutine for automating report printing by search for and locating reports fitting an input description at pre-set intervals and printing reports located by the automated printing subroutine.

The system preferably additionally includes a web server for sending data to the clinical messaging client application program and for encrypting the data so that all data passed to the clinical messaging client application program is sent via encrypted connection to the web browser. The system preferably additionally includes a clinical messaging report processing program including a mechanism for reading reports received through the at least one clinical messaging report interface and for loading the reports into the clinical messaging data repository; and including a mechanism for pulling data off the reports and using the data to populate the data repository and each given report, the clinical messaging report processing program having built-in templates for each report category it processes. The clinical messaging data repository preferably contains a user database for storing user profiles, user preferences and user authentication credentials.

The system preferably still additionally includes a clinical messaging faxing system including a clinical messaging fax dispatcher for determining the reports that need to be faxed and submitting these reports to a database for faxing; and a clinical messaging fax server for faxing reports submitted by the clinical messaging fax dispatcher and for batching up all reports that go to a doctor office into a single fax. The system preferably yet further includes a clinical messaging user administration program for changing user profiles, and a clinical messaging scheduling administration program for giving health care personnel the ability to read, print and process scheduling requests submitted by clinical messaging users.

A method is provided of receiving, categorizing, storing and selectively retrieving clinical messages through the World Wide Web, the system including at least one originating source at which a user inputs and retrieves data; a clinical messaging report processing program including a number of report templates for matching corresponding report categories and an accessing mechanism for a receiving, categorizing, storing and selectively retrieving client reports by report category; a web browser, wherein the clinical messaging client application program resides and executes in the web browser; a centralized data repository running the clinical messaging client application program and connected to the at least one originating system via the World Wide Web; and a clinical messaging report interface for importing and extracting data from reports received from the at least one originating source from the at least one originating source, the method including the stems of: a user transmitting data constituting at least one clinical report; the main data center receiving the report and comparing the report with templates stored in the logic of the program until a matching template is found; processing the report according to the rules of the matching template; storing the processed report in the clinical messaging data repository in such a manner as to be accessible for viewing; operating a computer at the originating source to select at least one of the reports by category and to access the at least one report.

The method preferably additionally includes the steps of: opening a report to be processed; reading the report type; using report rules to pre-process the file; using a template to build sql command to send report and data to the database server; and sending the report to the database server. The method preferably still additionally includes the steps of: reading report received from the clinical messaging report interfaces using the clinical messaging report processing program; and pulling data off the report and using the data to populate the database and to populate the report using the clinical messaging report processing program. The method optionally additionally includes the steps of determining the reports that need to be faxed and submitting these reports to the fax server using the clinical messaging fax dispatcher.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a schematic representation of the system hardware, and well as a clinical messaging logical diagram.

FIG. 2 is a chart of the clinical messaging in-bound report process flow.

FIG. 3 is a chart of the clinical messaging GUI features.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

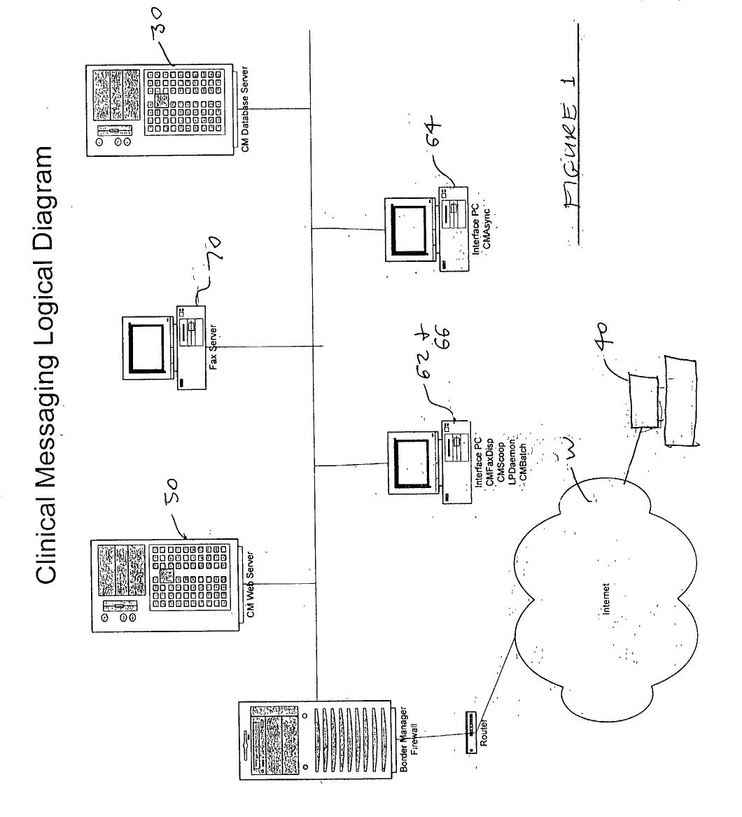

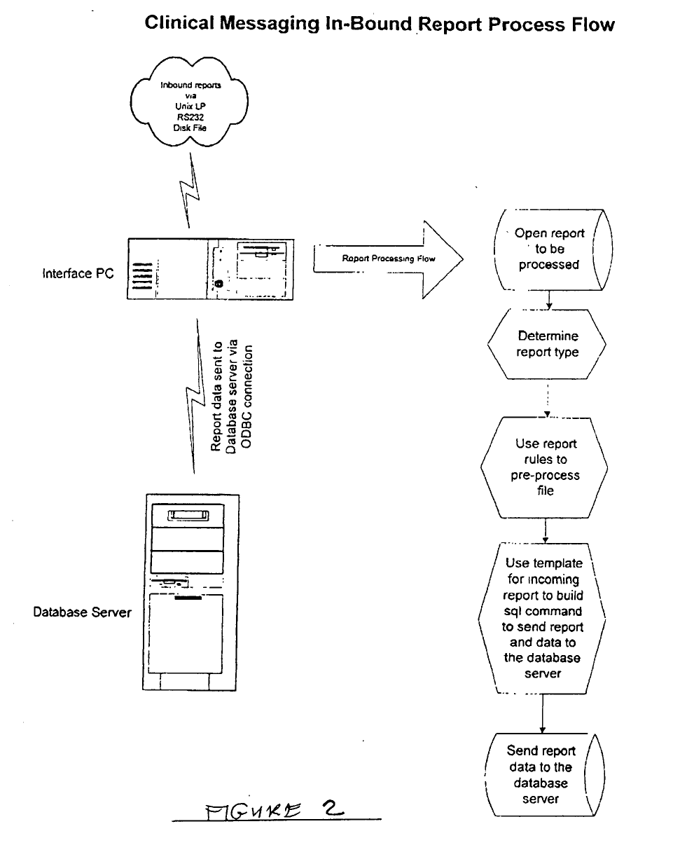

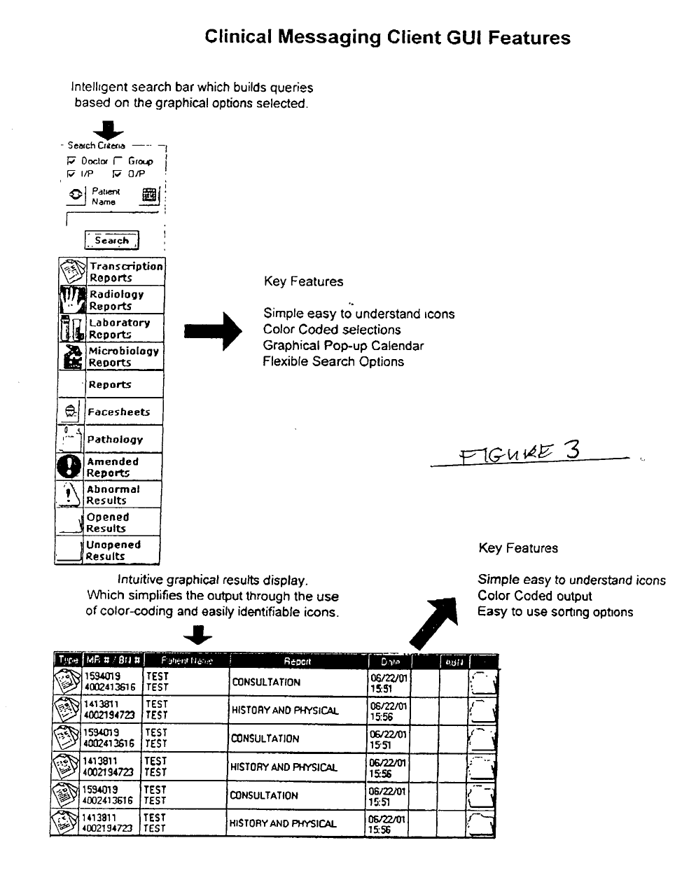

Referring to FIGS. 1-3, a computer operated clinical messaging system 10 and method for receiving, categorizing, storing and selectively retrieving through the World Wide Web clinical messages are disclosed, these messages typically taking the form of clinical reports of doctors about patients.

### The Clinical Messaging System

The system S includes at least one originating source 20 such as the computer system of a hospital or of a doctor office at which a user such as a doctor or medical staff member inputs and retrieves data, a centralized data repository 30 located in a main data center containing and running a clinical messaging report processing program and connectable to the originating system via the World Wide Web W. The clinical messaging client application program includes means for accessing client reports by type or category, such as radiology, lab, or transcription reports, or reports generated over a given selected date range and such as by patient name, medical record number, test name or date, or by multiple categories which are overlapped to produce a selected collective subcategory. The application program preferably is an ActiveX Document which is accessed via Internet Explorer™ such as MicroSoft™ Browser.

The clinical messaging client application program preferably executes in a Web Browser 40, preferably Internet Explorer, and preferably is built with Microsoft Visual Basic Enterprise Edition 6.0™. All data is requested and received by the clinical messaging client application program by way of SSL 128 bit encrypted data connection to the Web Server 50.

The clinical messaging client application program preferably includes an automated printing subroutine called “Auto Print” for automating the printing process by checking for reports fitting an input description at pre-set intervals, such as every 60 seconds, and printing the new reports. The preferred database engine for storing the reports, the system operating parameters and logs is Microsoft™ SQL 7.0 server, running on the Windows 2000 Advanced Server™.

System 10 includes a web server 50 for sending data to the clinical messaging client application program, and the preferred web server 50 is the Microsoft IIS 5.0 Web Server™, running on the Windows 2000 Advanced Server™. The web server 50 encrypts the data with SSL 128 bit encryption using a secure certificate issued by Verisign™, so that all data passed to the clinical messaging client application program is generated by Active Server Page™ scripts and sent via encrypted SSL connection to the web browser 40 where the program resides.

System 10 preferably includes three separate clinical messaging report interfaces 62, 64 and 66 for receiving the reports. One interface 62 is a program known as LPDaemon™ which receives reports from UNIX-based systems and preferably is written using Microsoft Visual Basic™. A second interface 64 is a program known as CMAsync™ which receives reports from rs-232 connected systems and which is preferably written using Microsoft Visual Basic™. A third interface 66 is a program which pulls reports from local network based file systems and preferably is written using Microsoft Visual Basic™.

System 10 includes a clinical messaging report processing program for reading reports received from the clinical messaging report interfaces 62, 64 and 66 and for loading the reports into the clinical messaging data repository 30. The clinical messaging data repository 30 preferably contains a user database which stores user profiles and preferences and user authentication credentials. The clinical messaging report processing program pulls data off the reports and uses this data to populate the data repository/database as well as the report itself. The clinical messaging report processing program has built-in profiles for each report type it processes and the program preferably is written using Microsoft Visual Basic™.

System 10 includes a clinical messaging faxing system 70 which consists of two components: a clinical messaging fax dispatcher program for determining the reports that need to be faxed and for submitting these reports to a database for faxing, and a clinical messaging fax server program for faxing reports submitted by the clinical messaging fax dispatcher program and for batching up all reports that go to a doctor office into a single fax for maximized efficiency. The clinical messaging fax dispatcher program and the clinical messaging server program preferably are written using Microsoft Visual Basic™.

System 10 preferably further includes a clinical messaging user administration program for giving the Healthcare System Help Desk and IT Personnel the ability to change user profiles. The clinical messaging user administration program preferably is written using Microsoft Visual Basic™.

System 10 preferably further includes a clinical messaging scheduling administration program for giving Healthcare System Scheduling Departments the ability to read, print and process scheduling requests submitted by clinical messaging users. The clinical messaging scheduling administration program preferably is written using Microsoft Visual Basic™.

### Method of System Operation

In practicing the invention, the following method may be used. A user transmits data constituting at least one clinical report; the report processing program receives the report and compares the report with templates stored in the logic of the program and then if a match is found it sends the report to the data repository; the clinical messaging client application program processes the report according to the rules of the matching template; the clinical messaging clinical messaging report processing program stores the processed report in the clinical messaging data repository 30 in such a manner as to be accessible for viewing; the fax server prints or telefaxes the report based upon parameters of the report; a user at an originating source 20 operates a computer station to select one or more of these reports by patient name and/or by data category and to access the report and view, print and/or telefax the report. Additional method steps are as follows. The web server 50 sends data to the clinical messaging client application program, the web server 50 encrypts the data and sends it to the clinical messaging application program which de-crypts the data for presentation to the user; the clinical messaging report processing program reads reports received from the clinical messaging report interfaces 62, 64 and 66; the clinical messaging report processing program pulls data off the reports and uses the data to populate the database and to populate the report; and the clinical messaging fax dispatcher determines the reports that need to be faxed and submits these reports to the fax server.

All reports stored in the clinical messaging data repository 30 are accessible to all users through the selecting and accessing steps, unless those who maintain the data repository 30 have reason to segregate and restrict access to one or more of the reports. It is preferred that the clinical messaging data repository 30 retain reports for a pre-set, fixed time period, such as ninety days, and that reports be purged after passage of the fixed time period. Yet it is also preferred that the clinical messaging data repository 30 retain detailed transaction levels logs indefinitely.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A computer operated clinical messaging system for receiving, categorizing, storing and selectively retrieving clinical messages through the World Wide Web, said system comprising:
at least one originating source at which a user inputs and retrieves data;
a clinical messaging report processing program comprising a plurality of report templates for matching corresponding report categories and accessing means for a receiving, categorizing, storing and selectively retrieving client reports by report category;
a web browser, wherein said clinical messaging client application program resides and executes in said web browser;
a central data repository, wherein said clinical messaging report processing program feeds data to said central data repository;
and a clinical messaging report interface for importing and extracting data from reports received from said at least one originating source from the at least one originating source.

2. The system of claim 1, wherein said clinical messaging client application program comprising means for a receiving, categorizing, storing and selectively retrieving client reports by overlapping a plurality of report categories.

3. The system of claim 1, wherein said application program is an ActiveX Document which is accessed via Internet Explorer.

4. The system of claim 1, wherein said report categories comprise at least one of: radiology reports, lab reports, transcription reports, reports generated over a selected date range, reports for a patient having a certain patient name.

5. The system of claim 1, wherein said originating source is a computer system in a hospital.

6. The system of claim 1, wherein said originating source is a computer system in a doctor office.

7. The system of claim 1, wherein said clinical messaging client application program comprises an automated printing subroutine for automating report printing by search for and locating reports fitting an input description at pre-set intervals and printing reports located by said automated printing subroutine.

8. The system of claim 1, additionally comprising a web server for sending data to said clinical messaging client application program and for encrypting the data such that all data passed to said clinical messaging client application program is sent via encrypted connection to said web browser.

9. The system of claim 1, additionally comprising:
a clinical messaging report processing program comprising means for reading reports received through said at least one clinical messaging report interface and for loading the reports into said clinical messaging data repository;
and comprising means for pulling data off the reports and using the data to populate said data repository and each given report, said clinical messaging report processing program having built-in templates for each report category it processes.

10. The system of claim 1, wherein said clinical messaging data repository contains a user database for storing user profiles, user preferences and user authentication credentials.

11. The system of claim 1, additionally comprising a clinical messaging faxing system comprising:
a clinical messaging fax dispatcher for determining the reports that need to be faxed and submitting these reports to a database for faxing;
and a clinical messaging fax server for faxing reports submitted by said clinical messaging fax dispatcher and for batching up all reports that go to a doctor office into a single fax.

12. The system of claim 1, additionally comprising a clinical messaging user administration program for changing user profiles.

13. The system of claim 1, additionally comprising a clinical messaging scheduling administration program for giving health care personnel the ability to read, print and process scheduling requests submitted by clinical messaging users.

14. A method of receiving, categorizing, storing and selectively retrieving clinical messages through the World Wide Web, said system comprising at least one originating source at which a user inputs and retrieves data; a clinical messaging report processing program comprising a plurality of report templates for matching corresponding report categories and accessing means for a receiving, categorizing, storing and selectively retrieving client reports by report category; a web browser, wherein said clinical messaging client application program resides and executes in said web browser; a central data repository, wherein said clinical messaging report processing program feeds data to said central data repository;
and a clinical messaging report processing program for importing and extracting data from reports received from said at least one originating source from the at least one originating source, wherein the method comprises the steps of:
a user transmitting data constituting at least one clinical report;
the report processing program with the data repository receiving the report and comparing the report with templates stored in the logic of the program until a matching template is found;
processing the report according to the rules of the matching template;
storing the processed report in the clinical messaging data repository in such a manner as to be accessible for viewing;
operating a computer at said originating source to select at least one of said reports by category and to access the at least one report.

15. The method of claim 14, additionally comprising the steps of:
sending data to the clinical messaging client application program using the web server;
and encrypting the data using the web server.

16. The method of claim 14, additionally comprising the steps of:
reading report received from said clinical messaging report interfaces using the clinical messaging report processing program;
and pulling data off the report and using the data to populate the database and to populate the report using the clinical messaging report processing program.

17. The method of claim 14, further comprising the steps of:
determining said reports that need to be faxed and submitting these reports to said fax server using said clinical messaging fax dispatcher.

18. A method of receiving, categorizing, storing and selectively retrieving clinical messages through the World Wide Web, said system comprising at least one originating source at which a user inputs and retrieves data; a clinical messaging report processing program comprising a plurality of report templates for matching corresponding report categories and accessing means for a receiving, categorizing, storing and selectively retrieving client reports by report category; a web browser, wherein said clinical messaging client application program resides and executes in said web browser; a central data repository, wherein said clinical messaging report processing program feeds data to said central data repository; and a clinical messaging report interface for importing and extracting data from reports received from said at least one originating source from the at least one originating source, wherein the method comprises the steps of:
opening a report to be processed;
reading the report type;
using report rules to pre-process the file;
using a template to build sql command to send report and data to the database server;
and sending the report to the database server.
